(19) United States
(12) Patent Application Publication
(10) Pub. No.: US 2006/0228294 A1
(43) Pub. Date: Oct. 12, 2006

(54) Process and apparatus using a molten metal bath

(76) Inventors: William H. Davis, Wincester, MA (US); Igor Polovtsev, Forest Hill, MD (US)

Correspondence Address: Eugene Berman;Law Offices of Eugene Berman, 26 Cedarwood Court, Rockville, MD, 20862, US

(21) Appl. No.: 11/400,973

(22) Filed: Apr. 10, 2006

Related U.S. Application Data
(60) Provisional application No. 60/670,332, filed on Apr. 12, 2005.

(51) Int. Cl. B01J 8/02; F01N 3/20

(52) U.S. Cl. 423/659; 422/105

(57) ABSTRACT

Processes and apparatus for treating organic and inorganic materials in a metal bath contained in a high temperature reactor to produce synthesis gas are provided. The feed materials are prepared and analyzed for heat value prior to injection and the composition of materials in and exiting the reactor are monitored. Based upon the results of the analysis and monitoring, oxygen, steam, and/or other feed materials are also injected into the reactor, to control processing and synthesis gas quality.

### CROSS-REFERENCE TO RELATED APPLICATIONS

This application claims the benefit of U.S. Provisional Application No. 60/670,332, filed Apr. 12, 2005.

### BACKGROUND OF THE INVENTION

Organic and inorganic materials can be converted into vitrified material and a synthesis gas mixture of CO and H₂ (commonly referred to as “syngas”) by various means. It would be desirable to convert such materials into higher value, beneficially usable products (e.g.; conversion of large amounts of municipal solid waste into relatively small volumes of unleachable vitreous material and metals, and large volumes of syngas containing significant BTU value).

In the past, attempts have been made to convert wastes and other organic materials into syngas. Such processes include the steam conversion of organic material, which requires a substantial energy input. Other processes involved the use of metal baths or the use of plasma technologies. One of the greatest challenges in gasifying such feed materials is the feeds' unpredictable nature (e.g.; the feed materials' chemical and physical characteristics could change dramatically in a short period of time).

Though many of those attempts appear to have been technically possible and/or may have been successful in pilot scale demonstrations, these technologies did not allow for appropriate scaling or commercialization of the process because of the difficulty is processing the material in an economical manner, reliability of operation, controlling temperature and other key process variables, such as oxygen and steam input, etc. It would be highly desirable to have a commercially viable method for the conversion of large volumes (e.g., tons per hour) of organic and inorganic materials into synthesis gas of sufficient BTU value for commercial use and vitreous material which is useable (or at least environmentally benign)

### BRIEF DESCRIPTION OF THE INVENTION

The present invention provides methods and apparatus for the conversion of feed materials containing organic and inorganic components in a refractory lined vessel having one or more inlets and outlets, and partially filled with molten metal and vitreous material, to provide for production of syngas. The syngas is formed by the partial oxidation of the organic components of the feed materials and recovery of the vitreous material and metals from the inorganic components of feed materials. The method includes (1) providing one or more feed materials, from which air has been extracted and analyzing the feed materials for heat value; (2) injecting the feed materials directly into the molten metal; (3) monitoring the composition of the molten metal, the vitreous material, the synthesis gas and the reactor temperature; (4) injecting oxygen, steam and/or co-feeding one or more additional feed materials of higher heat value than the analyzed feed materials, with the amounts injected being based upon the analysis and monitoring results; and (5) continuously removing synthesis gas and periodically removing metal and/or vitreous material from the reactor. An overall process diagram is presented on FIG. 1 and is more fully discussed hereinafter.

The invention also provides an apparatus for the processing of organic and inorganic feed material comprising (1) a refractory lined vessel having one of more inlets and one or more outlets, and suitable for the containment of molten metal; (2) feed material preparation units (such as dryer and shredders); (3) analyzers for continuously analyzing the feed material prior to injection into the vessel; (4) injectors for injecting air-extracted feed material into the vessel; (5) monitors for the composition of the metal, the vitreous material and the synthesis gas; (6) injectors for injecting steam into the vessel at a predetermined level above which the molten metal would be contained; (7) oxygen and co-feeds injectors for injecting these materials into the vessel at a predetermined level below which the molten metal would be contained; (8) controllers for regulating the amount of steam, oxygen, and co-feed injection, responsive to the results of said analyzers and monitors; and (9) outlets in the vessel for continuously removing syngas.

### BRIEF DESCRIPTION OF THE DRAWINGS

FIG. 1 is a flow chart of a process of the present invention for processing a waste stream, including preferred optional features of the invention.

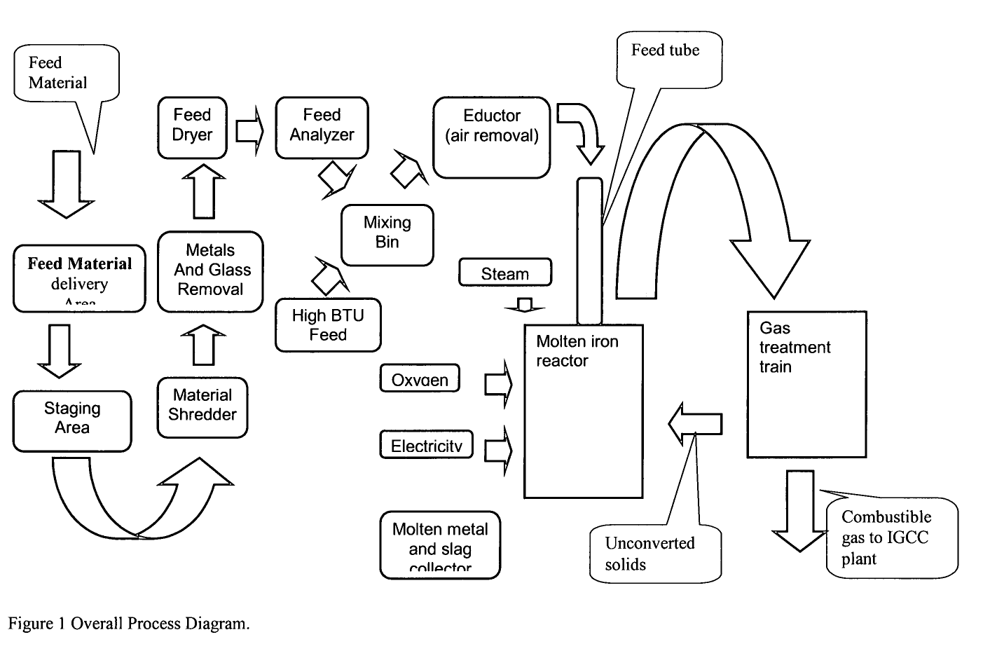

FIG. 2 is a schematic illustration of a feeding arrangement in one embodiment of the present invention.

FIG. 3 is a schematic illustration of a feeding arrangement in another embodiment of the present invention.

FIG. 4 is a schematic illustration of a product feed arrangement into the reactor for use in the present invention and a preferred reactor configuration.

FIG. 5 is an illustration of the chemical zones in the reactor.

### DETAILED DESCRIPTION OF THE INVENTION

The present invention provides for the conversion of one or more feed materials containing organic and inorganic components in a refractory lined vessel (as described below) which, in operation, is partially filled with molten metal and vitreous material. The feed materials are analyzed and selected to provide for optimal production of syngas formed by the partial oxidation of the organic components of the feed materials and recovery of vitreous material and metals from the inorganic components of feed materials.

Among the suitable feed materials are waste materials such as municipal solid waste (MSW), refuse derived fuels (RDF), including RDF based upon MSW, construction and demolition wastes (C&D), wastewater sludge, scrap tires, plastic wastes, medical waste, waste oils, as well as other non-waste materials such as coal or petroleum coke. Most preferred are MSW, C&D and other materials, which due to their carbon, hydrogen and oxygen content, can be efficiently converted to syngas by the practice of this invention. The advantages of the present invention are most relevant to the processing of solid feed materials, although non-solid material (e.g.; semi-solid mixtures and liquid feeds) may also be suitably processed.

Many of these feed materials (e.g.; MSW) have highly variable composition and physical form. In accordance with this invention, prior to injection into the reactor, the feed materials are prepared and analyzed for their heat values.

Feed material preparation includes the extracting of air from the feed material. The presence of air, which is 79% nitrogen, would result in a dilution of the syngas concentration and reduce its BTU value. In the practice of this invention, BTU value of the gas generated will preferably be in the range of 280-450 BTU/ft³. The feeder should ensure that essentially all of air contained in the waste is extracted. The most common concern in the material feeds is the presence of air, with the concern being based upon the nitrogen and other inert components which are present, not the oxygen component. It is preferred than the air or other inert gas content of the feed be less than about 1% of the weight of the feed, most preferably below about 0.5%. Although higher percentages will undesirably result in dilution of the syngas, somewhat higher percentages may be acceptable depending on the intended use of the syngas.

Depending on the nature of the feed material, the process of this invention will also typically include sizing, separating and drying steps to prepare the feed prior to injection. For example, for MSW, the feed material would typically go through:
1. a sizing process (e.g.; reduced in size to less than 1″ to 2″ to simplify any later extraction of inorganic materials and facilitate injection),
2. a separation process (e.g.; to separate out ferrous and non ferrous metals, concrete and glass.
3. a drying process to reduce the moisture content of the feeds. For example, the moisture content in many feeds can vary from 20% to 60% moisture. In order to achieve optimal gasifier performance, a stable moisture level below 10-20% is most preferred. Further, in order to minimize the risk of steam explosion moisture levels below 10% is generally required.

For some feed materials one or more of these steps may not be needed and/or will have been previously provided. For example, the feed material (e.g.; RDF prepared by a third party) may be received already sized and/or dried. To the extent some or all of this preparation steps are needed, they can be carried using standard waste industry equipment available from multiple vendors (e.g.; Alan-Ross Machinery Corporation, Northbrook, N.Y. and others provide suitable sizing equipment).

Feed material analysis is performed, so as to ascertain the nature of the feed prior to the injection thereof into the reactor; and additional feeds (as discussed below) can be simultaneously injected to address this variability. The feed can be analyzed either prior to, during, or subsequent to its preparation; with analysis of the feed after its preparation generally being most preferred, because the prior sizing, drying, and air extraction simplifies the analysis.

The analysis is designed to continuously and accurately estimate the heat value of the feed on a real-time basis prior to injection into the reactor and this can be done by analyzing the compositional makeup of the feed materials. One such analytical approach particularly useful herein is based upon neutron radiation, which is capable of inducing secondary gamma radiation in a wide range of material, and the gamma radiation is specific to elements. Almost all known elements including carbon, silicon, aluminum, calcium, oxygen and hydrogen will emit secondary gamma radiation. For example, when a feed material is irradiated by a neutron beam impulse produced by a neutron beam generator, the material will emit gamma radiation for a short period of time and an associated device measures these gamma ray emissions. The spectrum generated thereby is resolved in frequency and time elapsed from the neutron beam pulse and can accurately predict elemental composition (H, C, O, Si, Al, Ca and other element-based concentrations) of the analyzed stream. These measurements are done in a pulse mode, with more than one pulse per second. It typically takes about 15 seconds for software to analyze the signal and generate commands to the control module. Accordingly, the material feed stream analyzer should be installed at a point allowing sufficient time for the system to respond prior waste being fed into reactor. One such suitable neutron beam generator/gamma radiation detector/analyzer system is available from HIEnergy Technologies, Irvine Calif. or STS-Rateck, St Petersburg, Russia. Through the measurement of the composition of the feed material, a real time estimated heat value of the analyzed stream is established prior the material being fed into reactor. Based upon a predetermined computer algorithm, a controller will then adjust process parameters to better treat the incoming stream. The algorithm generates a theoretical heat value based on the elemental composition of the analyzed feed stream. It also generates required adjustments to the process parameters: feed rate, induction furnace heat, lime or soda ash addition, oxygen and steam flow.

In addition, the same measurements would preferably be used for estimating inorganic additions to the slag, such as aluminum, calcium, silicon and others. Using this analysis and a computer algorithm, a controlled amount of flux can be added to the feed stream to achieve desired viscosity of the slag layer. Correct viscosity of the slag layer is important because it allows for fast and reliable removal from the reactor. In order to achieve optimal vitreous material removal, its viscosity is preferably about 250 poise at a temperature of 200° F. below the reactor's operation temperature.

The step of injecting the prepared feed materials into the metal bath is also important. The materials are directly injected into the metal layer. The feed materials can be fed from the top of the reactor into the center of a molten metal bath and are preferably fed directly into the metal layer itself (i.e.; the feeding tube is immersed in the molten metal or molten vitreous material). In each instance, it is important that the injection not result in the entrainment or addition of air or inert gases (e.g.; use of conventional feeding lances utilizing air or nitrogen for material transport would unacceptably add air into the vessel). The type of feed mechanisms suitable for use in this invention includes auger extruder feeders (e.g., Model No. GPT2-2-400-00, manufactured by Komar Industries, Columbus, Ohio) and ram feeders (e.g., as manufactured by Robson Handling Technology, Recycling Equipment Corporation and others). The feed material (or at least a substantial portion thereof) reaches the bath in a solid form because it is pushed through the feeding tube fast enough not to be gasified in it. It is important that such feed mechanisms assure that waste is delivered underneath and not above the metal or vitreous layers and in a fast enough manner so that the waste does not undergo an unacceptably high rate of decomposition in the feeding tube.

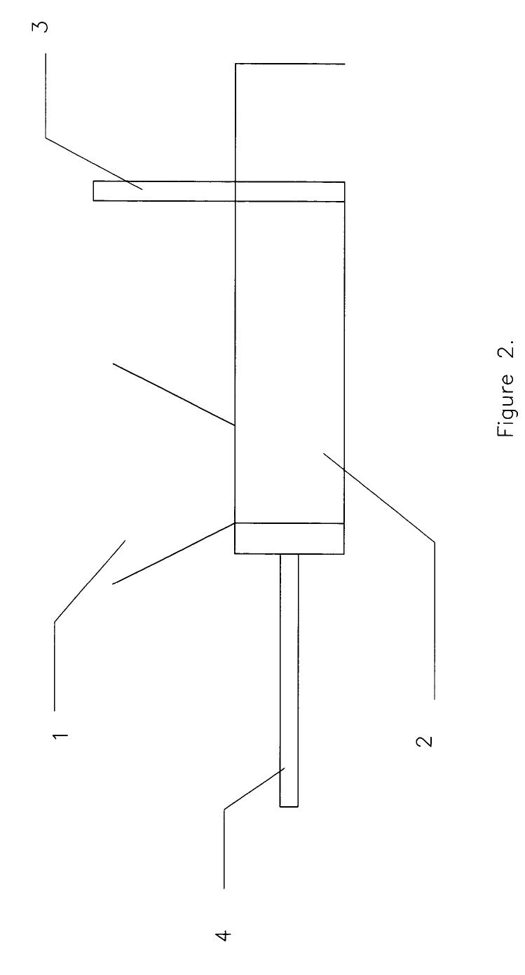

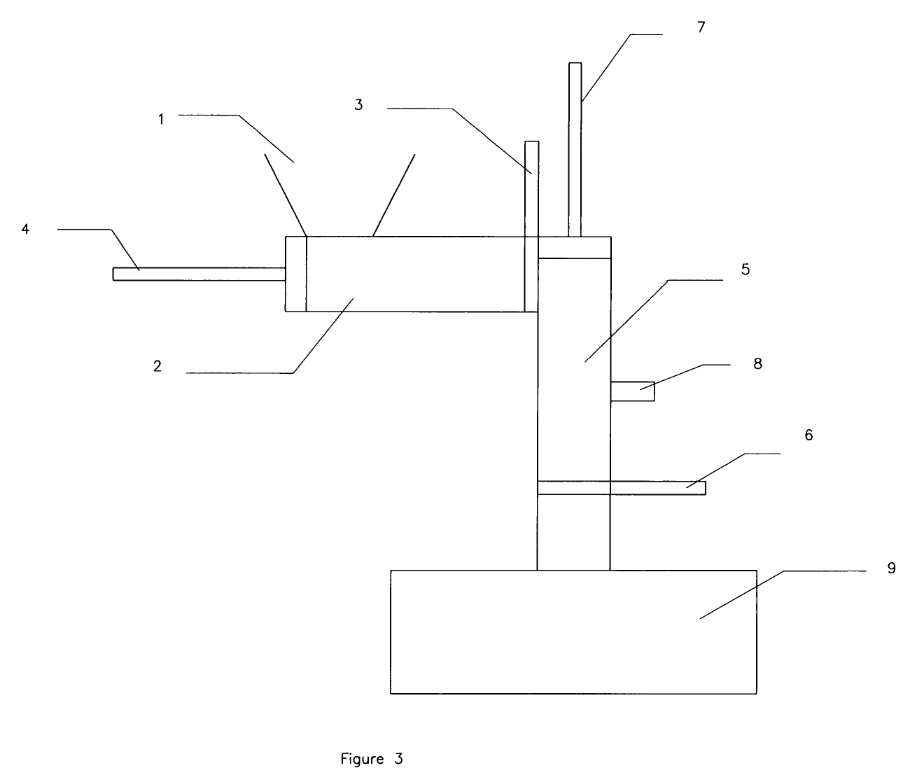

To achieve these objectives preferably involves one of the following three variants of the feeding step:
1. Product from the hopper (1) (FIG. 2) is gravity fed into the charge box (2). The gate (3) is in a closed position. The ram (4) moves forward and compresses the product with high pressure so that essentially all of the air from it escapes through the hopper (1). The amount of pressure delivered to the ram, and the sizes of the charge box, are determined by the type of product to be converted and by the required throughput of the overall system.
2. Product from the hopper (1) (FIG. 3) is gravity fed into the charge box (2). The gate (3) is in a closed position. Gate (3) opens and the ram (4) moves forward, pushing the product into the box (5). Gate (3) is closed. Gate (6) is closed as well. All the air is evacuated by suction (8) from box (5). Gate (6) opens and ram (7) moves product into the reactor (9).
3. Product is forwarded to the hopper. From hopper product is forwarded into extruder feeder, which moves it into the reactor.

The preferred method of feeding material is into the molten metal itself. When product is fed on the top of the molten bath, special precautions need to be taken to eliminate the possible discharge of the volatile organic compounds, carbon dioxide, and water to the output of the reactor. To avoid this, additional reaction space for the gas phase would preferably be added. This part of the reactor also needs to be furnished with oxygen and steam injection ports to maintain control over the atmosphere in the reactor and allow appropriate corrections if the product stream is changed.

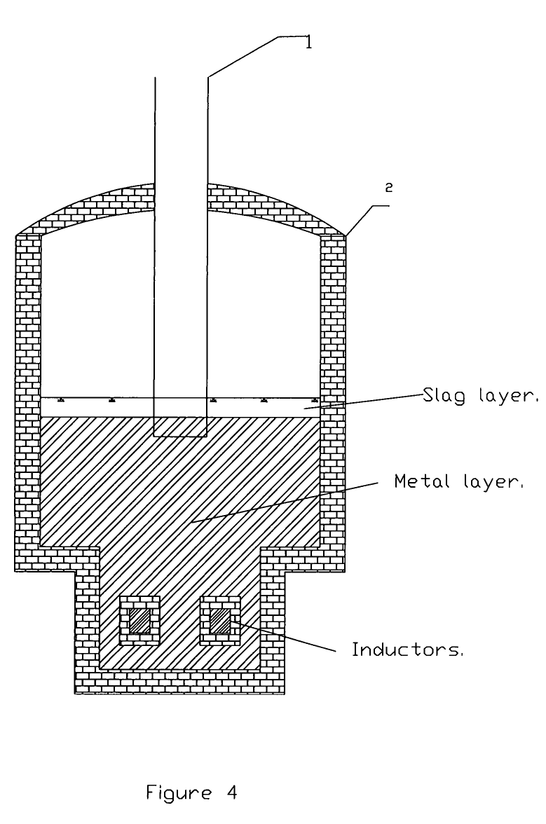

Product is fed directly into the vitreous layer of the molten bath (see FIG. 4). In one of the variants, the feeder itself (1) is inserted into the metal through the vitreous material. The compressed chunk coming out of the feeder is pushed down through the passageway (2) into the reactor underneath the vitreous material (3). This feeding arrangement has a significant advantage over top charging, because it eliminates or minimizes the possibility of the presence of volatile organic compounds in the synthesis gas and reduces particulate load on any associated gas treatment system thereby reducing requirements for the reactor size. The end of the feeder can be furnished with grating designed to cut though the compressed log of the material, and by doing so increases product surface area. Though water cooled tubes can be used in this arrangement, it is preferable to use a graphitized alumina unit (such as one manufactured by Vesuvius, Falconer, N.Y.) which is a combination of refractory (graphitized alumina or graphite) bottom submerged section of the tube, and water cooled colorized copper upper section.

The process also includes monitoring the composition of the molten metal, the vitreous material, the synthesis gas, and the reactor temperature.

Composition, temperature and volume of syngas are continuously analyzed. Concentrations of O₂, CO, CO₂, H2, H₂S, H₂O and particulate in the syngas are continuously monitored in real time (e.g.; using available monitoring equipment such as available from Rosemout Analytical Inc.).

Further, the compositions of the molten metal and the vitreous material are intermittently analyzed The metal samples of tapped metal are analyzed for metal composition and melting temperature in any commonly available metallurgical laboratory. If melting temperature of alloy approaches the operating temperature, some pig iron may be added to the feed to lower the temperature. Samples of vitreous material are sent to a laboratory such as Hazen Research Inc., Golden, Co for oxide composition and carbon content.

The data from this analysis, together with the analysis of the feed material, are used to control the process as discussed below.

Steam, oxygen, and/or co-feeds of additional feed materials of higher heat value than the analyzed feed materials are injected into the molten metal bath, with the amounts injected being based upon the analysis and monitoring results as described above.

The introduction of steam above the metal bath and oxygen directly into the metal bath are used to maintain the optimal concentration of oxygen in the reactor at all times, and to maintain a reduced oxidation environment. The amount of oxygen and steam injection will be controlled based upon reactor temperature input waste composition data provided by waste analyzer and by exhaust gas composition.

Additional feed materials of higher heat value than the analyzed feed materials (e.g.; scrap tires or rubber waste, if the principle feed material is MSW) can also be injected to help assure the quality of the syngas (e.g.; if a portion of the MSW feed is of lower than desired heat content).

If the temperature of the bath falls, induction power is increased. In the case of temperature increase, steam may be injected on the top of the bath to cool the process down with endothermic reaction discussed above. Normally water vapor concentration in the exhaust will be low if it increases, carbon concentration of the feed is dropped, and oxygen feed rate will be reduced. Other parameters may also be used to effectively adjust the gas cleanup train's performance.

The material is fed into a refractory-lined vessel such as an induction furnace, arc furnace or any other type of high temperature molten bath reactor. The reactor design should preferably be selected to assure that (i) it is sufficiently sized for the selected feed volumes and (ii) the amount of molten metal to be contained therein can be controlled at any given time so that the carbon content in the molten bath does not exceed about 4% by weight (based upon the weight of the molten metal). For example, for a 250 tpd MSW processing plant, a 40 ton steel capacity induction furnace preferably should be used, and have additional volume above the molten bath (head space) to accommodate gases rapidly exiting the bath, foaming of the vitreous material and the accumulation thereof during operation.

The preferred reactor configuration requires the reactor be equipped with the induction channels installed at the bottom of the vessel. Such a configuration is known as a channel furnace (e.g.; available from Ajax Tocco Magnetothemic, Inc., Warren, Ohio.). Electric power may be supplied in such a manner that electrical current is flowing through the channels. The molten metal may be heated by induction currents induced by alternating current flowing through the coils or loops. This allows unrestricted access to the reactor through the walls for tapping. In addition it allows multiple choices for refractory lining of the top cylinder including carbon graphite brick. As an alternative, a stand-alone induction furnace may be used to generate a molten bath, which is then charged into the reactor. The channel reactor (as shown in FIG. 4) is a refractory-lined vessel (1) with the molten metal material in it.

The metal is most typically iron, but other metals such as nickel, chromium, tin, etc. may also be advantageously used (e.g., to effect the conversion of chlorinated material in the feed to desired chlorine-containing form, such as HCl, or if a lower melting metal is necessary or desirable). A preferred variant is to use a separate standard induction furnace to melt steel and then charge it molten into the reactor.

Steam injection ports, which are located in the reactor above the molten bath layer, are provided. Suitable means to inject a predetermined amount of steam into the reactor include simple steam lances such as stainless steel nozzles manufactured by Spraying Systems Inc. Steam injection is effectively used to control the temperature of the process due to the endothermic reaction of water and carbon. In this process, injected steam reacts with the [C] which is present during operation above the bath, as shown in the following reaction:
C+H2O═H2+CO dH˜130 kJ/mole
This reaction will not only consume excess energy and reduce oxygen consumption but also will yield additional volumes of hydrogen in the exhaust. This is an endothermic reaction, which can rapidly and efficiently reduce the temperature in the reactor without jeopardizing synthesis gas output.

It is important that the steam be injected above the molten bath or in the vitreous layer, rather that into the metal itself, because most of elemental carbon will float to the top of the melt, and this area above the bath will also be the area which will need to be cooled fastest in case of higher than average heat value product fed into the reactor.

Oxygen should be injected directly into the metal bath or in the vitreous layer, rather than in the metal itself. Preferably, oxygen is supplied using one or more supersonic oxygen lances, which generate a gas stream capable of penetrating deep into the metal bath (i.e.; the exit of the lances are above the molten metal layer, but sufficiently adjacent thereto so that that the supersonic stream penetrates the molten metal layer). Alternatively, tuyere tubes to inject oxygen into the molten metal from the bottom of the reactor may also be used. Oxygen, after being injected into the molten metal, reacts with iron, forming iron oxide. When being fed into the reactor, the material feed submerges into the metal layer of the molten bath, where it is exposed to elevated temperatures in excess of 2900° F. These temperatures immediately initiate thermal decomposition of the material.

Suitable means to inject predetermined amounts of oxygen into the reactor include lances to inject oxygen from the top reactor and tuyere tubes to inject oxygen from the bottom of the reactor. Submerged lances and tueyers are possible but they significantly increase the possibility of catastrophic metal spill. Therefore, a preferred method of oxygen supply is by means of supersonic oxygen lances installed above the melt level, which generate a gas stream capable of penetrating deep into the metal bath. Oxygen, after being injected into the molten metal, reacts with iron, forming iron oxide. When being fed into the reactor, the material feed submerges into the metal layer of the molten bath, where it is exposed to elevated temperatures in excess of 2900° F. These temperatures immediately initiate thermal decomposition of the material.

The size of the reactor, the positioning of oxygen and steam injection nozzles, and the form of the exhaust gas passageway, will be selected dependent upon the product throughput and on the type of feed. It is advantageous to have oxygen and steam lances installed in the upper section of the reactor above the molten pool. Supersonic oxygen lances located above the molten pool and pointed downwards deliver oxygen into the bath itself not above it. One of the manufacturers of such lances is Process Technology International Inc, Tucker, Ga.

During processing, the organic portion of the material is converted into hydrogen and carbon and the inorganic constituents are melted and/or dissolved in the molten bath. The metal oxides are reduced to metals, which accumulate on the bottom of the molten bath, while all other inorganic compounds form the vitreous layer at the top of the molten bath. Carbon formed in this process floats to the surface of the molten bath. While doing so, it reacts with iron oxide reducing it to iron. In addition to this mechanism, direct carbon oxidation by oxygen with the formation of carbon monoxide also takes place. This continuous movement of waste and iron oxide up and iron down in the molten bath provide a necessary stirring action and facilitates the whole process.

The reactor is equipped with tapping mechanisms for excess metal and for the vitreous layer. The vitreous layer and accumulated metal are periodically tapped to maintain a constant level of the molten bath in the reactor. Suitable tapping mechanisms include: tapping drills, which are supplied by a number of manufacturers (e.g.; Woodings Industrial Corporation, Mars, Pa.) and a mud gun to plug the drilled hole. Size and type of the drill and gun will be determined by refractory thickness and its composition.

Synthesis gas generated in this process exits the reactor through a top opening. The reactor volume and dimensions above the bath are designed to maximize the synthesis gas production efficiency and to reduce particulate load in the gas stream. Additional boilers, scrubbers and compressors can be installed downstream depending on the specific requirements of the plant.

If the product stream includes chlorine- or fluorine-containing compounds, lime can be added into the vitreous material to neutralize them. After being fed into the furnace, the feed product is exposed to the molten bath, whether it sinks into the vitreous material (if fed from the top) or is already submerged into it. The temperature of the molten bath may be as high as approximately 3000° F., or higher. All inorganic compounds are melted. Special fluxes, such as but not limited to, soda ash and borax, may be added to the melt in order to lower melting temperatures for some of the oxides contained in the product. Lime may be added to the feed to correct pH of the vitreous material.

When exposed to the extremely high temperatures of the molten bed, organic compounds contained in the feed start to decompose into carbon and hydrogen. Hydrogen will immediately leave the bath. Part of the carbon will dissolve in the molten metal, and the remainder will move toward the top of the bath. Concurrently with the waste, oxygen is feed into the reactor. The oxygen dissolves in iron with the formation of FeO.

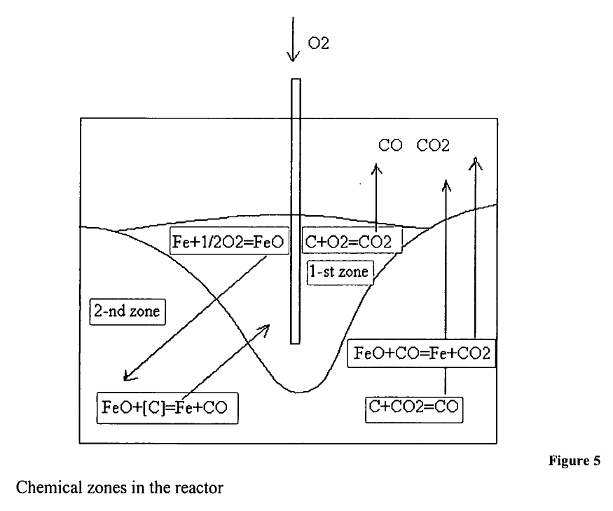

The molten bath reactor can be envisioned as separated into zones (FIG. 5). In the first zone, in the proximity of oxygen lances with excess of oxygen, the following main reactions occur:
Fe+1/2 O2=FeO dH˜−260 kJ/mole (T=1600 K)
with FeO being the dominant form of iron oxide in the reactor's preferred operating temperature range. Other reactions include:
2Fe+3/2 O2=Fe2O3 dH˜−800 kJ/mole
[C]+O2=CO2
All products of those reactions travel towards the top of the molten metal bath.

In the second zone, which has a lack of oxygen, carbon and any non-dissociated material feed are moving towards the top and are dissolved in the melt when they meet iron oxide. Reactions leading to the formation of carbon monoxide occur as follows:
FeO+[C]═Fe+CO dH˜150 kJ/mole (T=1600 K)
Fe2O3+[C]=2 Fe+3CO dH˜454 kJ/mole
CO+FeO═Fe+CO2 dH˜−20 kJ/mole
Carbon participating in this reaction exists in the reactor in three forms: free carbon, carbon dissolved in the melt, and carbon contained in still-not-disintegrated waste. Some of the carbon dioxide formed in zone one is reduced to CO:
CO2+[C]=2 CO dH˜160 kJ/mole
This gas continues to react with carbon, forming carbon monoxide. This is an exothermic reaction, which provides a heat source for the process. Special precautions need to be taken not to allow overheating of the system. The temperature of the reactor should be carefully controlled, and if it exceeds 3000° F., steam injection should be activated.

During operation, the temperature and level of the molten bath are preferably continuously monitored.

The present invention is particularly well suited to the processing of MSW, C&D and RDF. Prior approaches could not effectively deal with the challenges posed by the highly variable compositional makeup of MSW, particularly the inconsistency of its BTU content. For example the BTU of MSW and C&D can typically range from about 7500 BTU/cu ft (for streams containing high percentages of wood, paper and plastics) to as low as about 3000 BTU/cu ft for streams containing low percentages of the foregoing high BTU components and/or high percentages of low BTU material such as rock, glass, water and metal).

The present invention effectively deals with this BTU variability. The processes and apparatus herein (i) analyze the feed materials for heat value (e.g., preferably continuously using neutron beam-induced gamma radiation spectroscopy or by taking frequent samples and analyzing their heat value by calorimeter or other conventional methods) of incoming stream before introducing it into the reactor, (ii) monitor (preferably continuously or by periodic sampling) the composition of the molten metal for carbon content and metals; (iii) monitor (preferably continuously) the composition of the gaseous stream in the headspace of the reactor or in the off-gas stream (e.g., for H₂, H₂O, H₂S, CO₂ and carbon monoxide content by use of one or more gas analyzers and the temperature of such stream) and (iv) based upon the analysis and monitoring results, oxygen and/or co-feeds (other feedstocks such as shredded tires, petroleum coke etc. of known and/or higher BTU value) are injected (preferably dynamically blending), in order to achieve and maintain the desired BTU value in the off-gas stream.

Gas leaving the gas treatment system has heat value ranging from 290 BTU/cft to 450 BTU/cft and will be of suitable quality to be used in combined-cycle (CC) power plant. When such a unit is installed inline with combined-cycle power plant, one would be able to generate 1600 kW of electricity from each ton of material fed into the reactor, which is a significant improvement in comparison with the other waste gasifiers combined with CC power plant.

Though the molten bath and vitreous material layers both act as effective particulate filters, some of the carbon dust, especially when the reactor is fed from the top, can escape the molten bath and become airborne. Special oxygen injection ports may be located above the bath and direct oxygen flow in the upper portion of the reactor in order to supply sufficient amounts of oxidizer to convert carbon dust into carbon monoxide. To prevent particulates from exiting the reactor, the gas-exiting velocity should be lower than the dust-settling velocity. This can be achieved by adding expansion chambers in the exhaust section of the reactor. Another way of minimizing or eliminating particulate material is to install a cyclone on the exit from the reactor.

This process will continuously remove synthesis gas and periodically remove metal and/or vitreous material. These materials are removed through one or more outlets from the refractory-lined vessel and the removal can be accomplished by a conventional means well known in the metal manufacturing and/or waste processing arts.

The gaseous stream may be further treated as necessary or desirable. A preferred method of treating particulate and impurities in the syngas is to treat it with plasma discharge in a manner which treats these particulate and impurities, but does not significantly oxidize or “burn” the CO portion of the syngas. The types of plasma discharge most suitable include microwave and inductive coupling plasma, which are capable of generating an appropriate type of non-equilibrium plasma electrode-less discharge. In such case, non-equilibrium plasma generators are installed at the inlet of the specially-designed reactor. All, or only the contaminated portion of the syngas, may be fed into the reactor through this inlet. Some oxygen can also be added to the process in order to convert carbon (C) to carbon monoxide (CO). The plasma discharge acts as a catalyst for a number of processes and produces particulate-free syngas at the outlet of reactor. If configured properly, plasma discharge can also convert H₂S contained in the syngas into hydrogen and elemental sulfur, which is separated from the gas stream. Plasma processing does not destroy pollutants in the gas stream by itself, but rather it creates favorable conditions for pollutant removal processes and therefore must be used in conjunction with conventional pollution control technologies.

Though most of chloride, fluoride and up to 40% of sulfur will be captured in the vitreous material, additional syngas cleaning may be necessary or desirable. In this case, to substantially clean the gas of chlorine, fluoride and sulfur, a dry scrubber, injecting sodium hydroxide or lime, can be installed in the exhaust. After that, ceramic filters or cyclone separators may treat gases, in order to eliminate any residual particulates. Another method is to use a sodium hydroxide solution in the wet scrubber installed before the compressor.

Heat contained in the gases can be recuperated in a heat exchanger. After the dry scrubber, the synthesis gas will be saturated with water, which may be removed after the gas is compressed (4) and cooled below its dew point.

The reactor should preferably be equipped with a tapping mechanism, which may be of the same type which is used to tap blast furnaces and electric arc furnaces. Though it is preferable to have a continuous tapping of metal and vitreous material in a full-scale process, similar results can be achieved with periodic tapping of the reactor, which can be easier to implement. While in operation, vitreous material and metal will accumulate in the reactor. The level of the molten bath should be carefully controlled, and if it rises above a pre-set point the tapping mechanism for the metal and/or vitreous material layer will be activated. The simplest and most reliable way to do so is to stop the feed, vent syngas from reactor, then tap sidewall of reactor at the level where the start-up amount of iron would be with standard tapping drill. Vitreous material and metal is then poured out of the reactor until the level of the bath reaches the drilled tapping hole. This hole is then filled with mud through use of a mud gun. This is a short procedure and the reactor is ready for operation again. Metals of suitable composition can be sold (e.g.; to foundries) after collection, and the vitreous material may also be beneficially used (e.g.; as aggregate).

### EXAMPLE

Dried pelletized refuse derived fuel (RDF) with a capacity of 250 tons per day (TPD) is processed in a 40-ton channel induction reactor (Ajax Model VS-40), modified to have a sealed lid and increased dimensions to provide additional head space. RDF at a rate of 10.4 tons an hour (TPH) is fed into the reactor through a feeding mechanism, consisting of a screw type educator feeder. This feeder accomplishes two tasks: air extraction from the RDF; and product is moved with the required speed to the feeding tube. The feeding tube is a graphitized alumina pipe with internal diameter (ID) of 4″. It is installed in the center of the reactor lid.

The RDF feed material as received has moisture content of about 35% and contains material of varying size. The feed material is prepared as follows: it is dried using a Eagle II (available from Sweet Manufacturing Company, Springfield, Ohio) to a moisture level of 7%, sized using a shredder (Model # VVZ-310 available from Vecoplan, LLC, High Point, N.C.) to an average size of about 1 inch, and air is extracted from the dried and sized feed material using an extruder/feeder (Model # GPT2-400-0, manufactured by Komar Industries, Columbus, Ohio), resulting in the feed material having less than about 1% air by weight.

The composition of the prepared material is then analyzed for C, H, O, Al, Si, Ca, Fe, Ni and other components and the heat content thereof is predicted using a neutron beam analyzer (Model # NBW-1 available from STS-Ratek, St. Petersburg, Russia).

The reactor lid is also equipped with oxygen and steam lances and a gas outlet. The reactor is sealed from the atmosphere and is initially charged with 40 tons of molten iron. Oxygen is continuously fed into the reactor at a rate of 66,000 cubic feet an hour (cft/hr). Organic materials are decomposed in the reactor with formation of 325,000 cft/hr of H, 256,160 cft/hr of carbon monoxide and 1700 lb/hr of vitreous organic material. Gaseous products exit the reactor through the exhaust passage. The vitreous organic material is accumulated in the form of slag layer on top of the bath.

The temperature and level of the bath, the gas composition, and the temperature and volume of the syngas leaving the reactor are each measured. The composition of the syngas is continuously analyzed for CO, H₂, H₂O, O₂, H₂S using a gas analyzer (Model # MLT 4 available from Emerson, St Louis, Mo.). The composition of the metal and the vitreous layers are intermittently analyzed in a commercial metallurgical laboratory.

The results of these measurements are used to control amounts of oxygen, steam, and/or co-feeds into the reactor. When the temperature of the molten bath rises above desired level, steam injection into reactor is activated and the endothermic steam shift reaction results in temperature reduction of the process and additional hydrogen production. When the compositional analysis of the feed material indicates that it is below a predetermined heat value, additional oxygen and/or scrap tires (which is a higher BTU value co-feed than RDF) are injected into the reactor to maintain the BTU value of the syngas in a range between 350 and 450 BTU/cu ft.

After a predetermined amount of vitreous organic material accumulates in the reactor, the level of the molten bath rises to the desired level. Feed to the system is interrupted and oxygen feed is gradually phased out. The reactor is purged of combustible gases and a tap hole is drilled in the sidewall of the reactor at the level of the original metal bath. All products accumulated in the reactor above this hole are poured out into a specially designed cart. The vitreous organic material and metal are later separated with metal being available for sale to (e.g., steel mills) and the vitreous organic material being available for use as construction aggregate. After the tapping operation is completed (which typically takes about 40-60 minutes), the tap hole is sealed with a mud gun and processing of the waste into combustible gas resumes.

What is claimed is:

1. Method of treatment of one or more feed materials containing organic and inorganic components in a refractory-lined vessel having one or more inlets and one or more outlets, and partially filled with molten metal and vitreous material, to provide for production of synthesis gas formed from by the partial oxidation of the organic components of the feed materials and for the recovery of vitreous material and metals from the inorganic components of feed materials, comprising:
a). providing one or more feed materials from which air has been extracted and analyzing the feed materials for heat value;
b). injecting the feed materials directly into the molten metal;
c). monitoring the composition of the molten metal, the vitreous material and the synthesis gas
d). injecting oxygen and/or co-feeding one or more additional feed materials of higher heat value than the analyzed feed materials into the molten metal bath, with the amount injected being based upon the analysis and monitoring results;
e). injecting steam into the portion of the refractory lined vessel above the molten metal, with the amount injected being based upon the analysis and monitoring results; and
f). continuously removing synthesis gas, and periodically removing metal and/or vitreous material, said removing being through said one or more outlets from the refractory lined vessel.

2. The method of claim 1 wherein said feed materials are selected from the group consisting of municipal solid waste, refuse derived fuels, construction and demolition wastes, wastewater sludge and scrap tires.

3. The method of claim 1 wherein said providing of feed material includes extracting air from said feed materials.

4. The method of claim 1 wherein said analyzing of feed material is provided by neutron radiation analysis.

5. The method of claim 1 wherein injecting the feed materials directly into the molten metal comprises injection through a high velocity nozzle.

6. The method of claim 3 wherein said extracting air results in less than about 1% weight of air in said feed materials.

7. The method of claim 1 further including fine filtering of the synthesis gas stream by passing said stream through a ceramic filter.

8. The method of claim 1 further including passing the synthesis gas stream though a gas treatment train.

9. The method of claim 1 further including utilizing the synthesis gas stream in a combine cycle turbine.

10. The method of claim 1 further comprising mixing of the material in the molten metal bath by the thermal energy produced by one or more induction channels at the bottom section of the reactor.

11. The method of claim 1 wherein the feed material is selected from the group consisting of municipal solid waste and construction and demolition waste.

12. An apparatus for the processing of organic and inorganic feed material into synthesis gas and vitreous material comprising:
(1) a refractory-lined vessel having one of more inlets and one or more outlets, and suitable for the containment of molten metal;
(2) one or more feed material preparation units;
(3) one or more analyzers for continuously analyzing the feed material prior to injection into the vessel;
(4) one or more injectors for injecting air-extracted feed material into the vessel;
(5) one or more monitors of the composition of the metal, the vitreous material, and the synthesis gas;
(6) one or more injectors for injecting steam into the vessel at a predetermined level above which the molten metal would be contained;
(7) one or more injectors for injecting oxygen and/or co-feeds into the vessel at a predetermined level below which the molten metal would be contained;
(8) one or more controllers for regulating the amount of steam, oxygen and co-feed injection, responsive to the results of said analyzers and monitors; and
(9) one or more of outlets in the vessel for continuously removing syngas.

13. Apparatus of claim 12 wherein said refractory-lined vessel is a channel induction furnace.

14. Apparatus of claim 12 wherein said one or more feed material preparation units is a dryer.

15. Apparatus of claim 12 wherein said one or more feed material preparation units is an air extractor.

16. Apparatus of claim 12 wherein said analyzers for continuously analyzing the feed material is a neutron radiation analysis device.
